(19) United States
(12) Patent Application Publication
(10) Pub. No.: US 2017/0083946 A1
(43) Pub. Date: Mar. 23, 2017

(54) METHOD AND SYSTEM FOR DATA-INFORMED ONLINE ADVERTISEMENT DELIVERY

(71) Applicant: comScore, Inc., Reston, VA (US)

(72) Inventors: Paul BARFORD, Reston, VA (US); Mike BROWN, Reston, VA (US); Rajesh BASHETTY, Reston, VA (US); Kevin SPRINGBORN, Reston, VA (US); Jon KOLLER, Reston, VA (US)

(21) Appl. No.: 14/857,821

(22) Filed: Sep. 18, 2015

(51) Int. Cl. G06Q 30/02

(52) U.S. Cl. CPC G06Q 30/0263

(57) ABSTRACT

Methods and systems for delivering a creative are disclosed. Initially, a first tag including a first link to the creative to be displayed on a webpage to be displayed on a first device is received. Next, a second tag corresponding to the first tag is generated, where the second tag includes a second link to a first set of instructions including instructions to forward a first rating request. The second tag is forwarded to a creative provider. Then, it is determined, based on first metadata of the first rating request, that a first rating satisfies a first set of parameters. Finally, the first tag including the first link to the creative is forwarded in response to the determination that the first rating satisfies the first set of parameters.

### FIELD OF THE DISCLOSURE

This disclosure generally relates to delivering a creative, and more particularly relates to delivering a creative to a client device when content within which the creative is inserted satisfies at least one parameter.

### BACKGROUND ART

A company that provides goods or services, or a non-profit entity advancing a particular cause, for example, may pay a website owner, known as a publisher or content provider, to include their advertisements or creatives (e.g., text, images, video, etc.) into one or more of the content provider's webpages. A creative provider may have its creatives delivered through multiple content providers or third-party advertising networks/brokers. The content provider may display creatives from multiple creative providers or third party advertising networks/brokers on any one of its webpages.

However, it may be desirable to restrict the display of some creatives on certain websites to protect brand safety. For example, advertisements targeted towards children may not be appropriate for websites with an adult demographic. A creative provider may not want to pay for an impression of a creative delivered to an inappropriate website. Further, a creative provider may also want to protect against impression or click fraud by not paying for an impression of an advertisement that is registered by non-human or other forms of invalid traffic. Current online advertisement systems cannot actively restrict the display of some creatives on certain websites.

Accordingly, there is a need to improve the control and delivery of creatives to websites.

### SUMMARY OF THE DISCLOSURE

The foregoing needs are met, to a great extent, by the computer-implemented method for delivering a creative described below. Initially, a first tag including a first link to the creative to be displayed on a webpage to be displayed on a first device is received. Next, a second tag corresponding to the first tag is generated, where the second tag includes a second link to a first set of instructions including instructions to forward a first rating request. The second tag is forwarded to a creative provider. Then, it is determined, based on first metadata of the first rating request, that a first rating satisfies a first set of parameters. Finally, the first tag including the first link to the creative is forwarded in response to the determination that the first rating satisfies the first set of parameters.

In some aspects, the first rating request including the first metadata corresponding to the webpage to be displayed on the first device is received at the analysis network and from the first device. The first rating is determined based on the first metadata of the first rating request at the analysis network. The analysis network determines that the first rating satisfies the first set of parameters.

In other aspects, the first rating request comprising the first metadata corresponding to the webpage to be displayed on the first device is received at the first device. The first rating is determined based on the first metadata of the first rating request at the first device. The analysis network determines that the first rating satisfies the first set of parameters.

In some aspects, a second rating request including second metadata corresponding to another webpage is received at the analysis network. A second rating based on the second metadata of the second rating request is determined. The analysis network determines that the second rating does not satisfy the first set of parameters. A third tag including a third link to a second creative is forwarded from the analysis network in response to the determination that the second rating does not satisfy the first set of parameters. The second creative may include a public service announcement. In some aspects, the determination that the second rating does not satisfy the first set of parameters can include determining that the second rating request was non-human traffic.

In some aspects, the second tag can include a JavaScript tag. The first metadata can include a URL of the webpage. In further aspects, the first metadata can also include at least one of a container of the creative, at least one cookie of the first device, a placement location of the creative, an identifier of the creative, and a response time of the first rating request.

In some aspects, the first rating can be a first alphanumeric value and the first set of parameters can be at least one alphanumeric value. The first rating can be determined to satisfy the first set of parameters by being equal to the at least one alphanumeric value of the first set of parameters, by being less than the at least one alphanumeric value of the first set of parameters, and/or by being greater than the at least one alphanumeric value of the first set of parameters.

In some aspects, the determination that the first rating satisfies the first set of parameters can include determining that the webpage does not include at least one unapproved keywords, the webpage is from an approved domain, and/or the first link was previously forwarded to a second device displaying the same webpage.

In some aspects, the second tag can include a tag identifier corresponding to the first tag. The first tag can be forwarded from the analysis network by selecting the first tag to forward based on the tag identifier. The first tag can also be forwarded from the analysis network to the first device.

A system for delivering a creative, where the system includes at least one processor connected to at least one storage device is also disclosed according to some aspects. An article of manufacture including non-transitory machine-readable media having instructions encoded thereon is also disclosed according to some aspects.

Certain aspects of delivering a creative have been outlined such that the detailed description thereof herein may be better understood and in order for the present contribution to the art may be better appreciated. There are, of course, additional aspects of the disclosure that will be described below and which will form the subject matter of the claims appended hereto.

In this respect, before explaining at least one aspect of delivering a creative in detail, it is to be understood that the delivering of a creative is not limited in its application to the specific steps or details set forth in the following description or illustrated in the drawings. Rather, other aspects in addition to those described can be practiced and carried out in various ways. Also, it is to be understood that the phraseology and terminology employed herein, as well as the Abstract, are for the purpose of description and should not be regarded as limiting.

As such, those skilled in the art will appreciate that the conception upon which this disclosure is based may readily be utilized as a basis for the designing other structures, methods, and systems for carrying out the several purposes of the delivering of a creative. It is important, therefore, that the claims be regarded as including such equivalent constructions insofar as they do not depart from the spirit and scope of the disclosure.

### BRIEF DESCRIPTION OF THE DRAWINGS

In order that the disclosure may be readily understood, aspects of this disclosure are illustrated by way of examples in the accompanying drawings.

FIG. 1 illustrates an exemplary hardware and network configurations between a content provider, a creative provider, an analysis network and a client device.

FIG. 2 illustrates an exemplary webpage of a content provider.

FIG. 3 illustrates an example of a process for generating a modified tag.

FIGS. 4A-4B illustrate an example of a process for delivering a creative.

The same reference numbers are used in the drawings and the following detailed description to refer to the same or similar parts.

### DETAILED DESCRIPTION

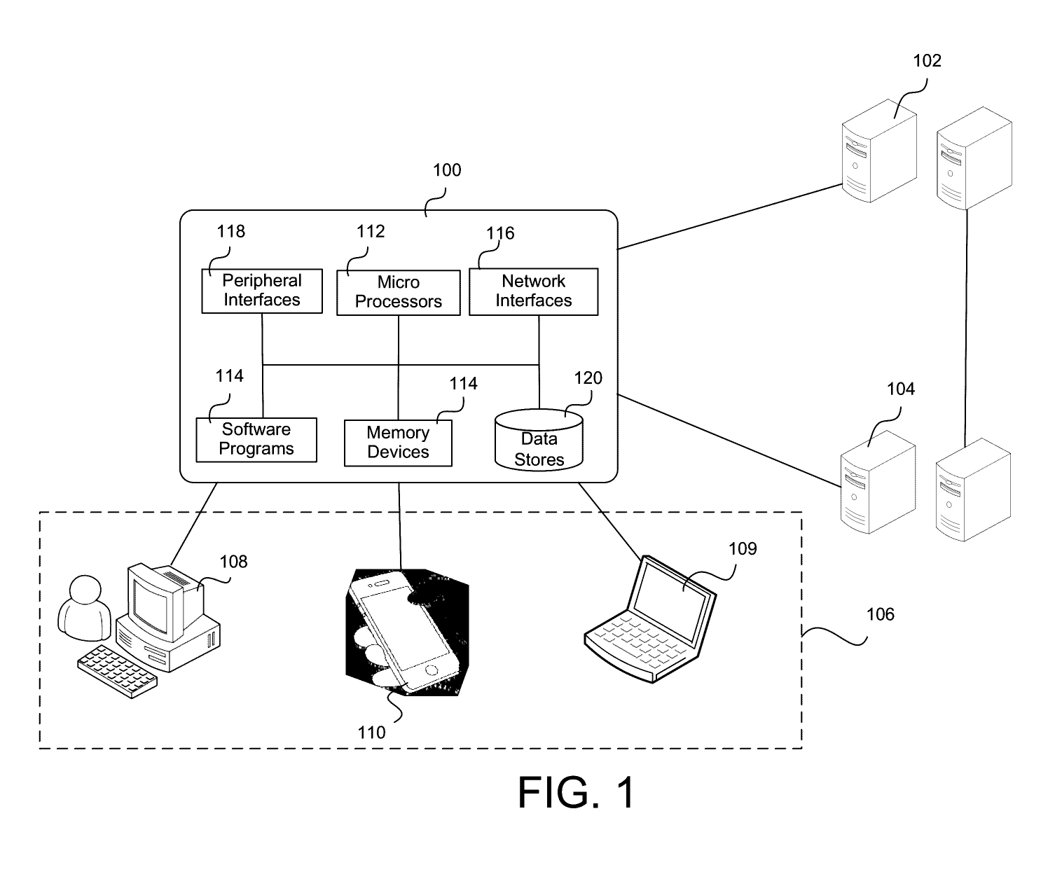

FIG. 1 illustrates exemplary hardware and network configurations for various devices that may be used to perform one or more operations of the described aspects. As shown, a content provider 100, a creative provider 102, and an analysis network 104 are in communication with one another. A content provider 100 may be a website owner or content publisher. The creative provider 102 may be a company seeking to market or sell products or services, or an advertisement agency or broker that may provide advertisements (i.e. creatives) to a content provider 100. The analysis network 104 may be a third-party seeking to receive information related to the advertisements received by the content provider 100 and assist the creative provider 102 in the delivery of a creative.

The content provider 100 may be in communication with a plurality of client devices 106. A client device 106 may be viewing a webpage or other web or application content of the content provider 100. As further described below, the client devices 106 may be the devices that receive an advertisement. The client devices 106 may include a personal computing device, such as a desktop 108 or laptop computer 109, a mobile device 110, such as a smartphone or tablet, a kiosk terminal, a Global Positioning System (GPS) device, etc. The client device 106 may receive client-side code to render a webpage from one or more external devices, such as a web server involved with serving webpages, advertisements, creative, or other information to the client device.

Although only the hardware configurations for the content provider 100 are shown in FIG. 1, each of the content provider 100, the creative provider 102, the analysis network 104, and the client devices 106 may include microprocessors 112 of varying core configurations and clock frequencies. These entities may also include one or more memory devices or computer-readable media 114 of varying physical dimensions and storage capacities, such as flash drives, hard drives, random access memory, etc., for storing data, such as images, files, and program instructions for execution by one or more microprocessors 112. These entities may include one or more network interfaces 116, such as Ethernet adapters, wireless transceivers, or serial network components for communicating over wired or wireless media using protocols, such as Ethernet, wireless Ethernet, code divisional multiple access (CDMA), time division multiple access (TDMA), etc. These communication protocols may be used to communicate between the content provider 100, the creative provider 102, the analysis network 104, and the client devices 106. These entities may also have one or more peripheral interfaces 118, such as keyboards, mice, touchpads, computer screens, touchscreens, etc. for enabling human interaction with and manipulation of devices of the content provider 100, the creative provider 102, the analysis network 104, and the client devices 106.

The content provider 100, the creative provider 102, the analysis network 104, and the client devices 106 may each have the computer-readable media 114 physically or logically arranged or configured to provide for or store one or more data stores 120, such as one or more file systems or databases, and one or more software programs 122, which may contain interpretable or executable instructions for performing one or more of the disclosed aspects. The components may comprise any type of hardware, including any necessary firmware or software for performing the disclosed aspects. The components may also be implemented in part or in whole by electronic circuit components or processors, such as application-specific integrated circuits (ASIC) or field-programmable gate arrays (FPGAs).

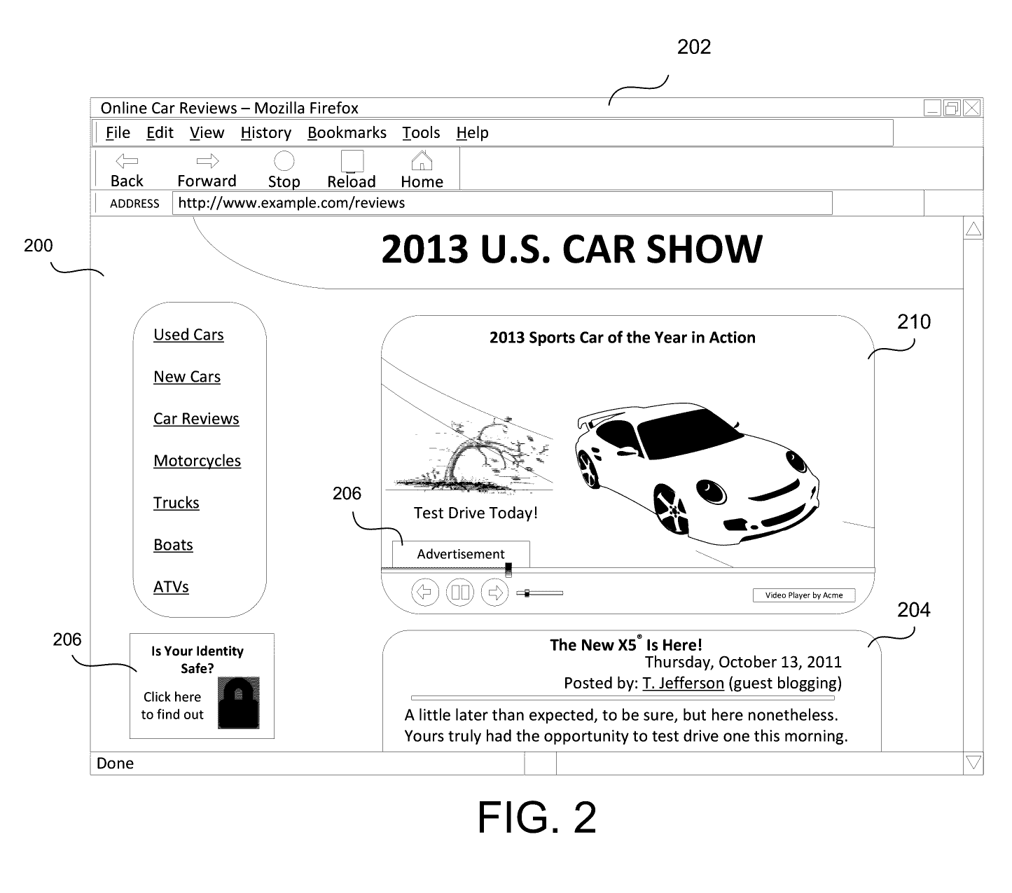

FIG. 2 is a diagram depicting an exemplary webpage 200 of the content provider 100. The webpage 200 may be rendered by a web browser 202 on a client device 106 and displayed on a screen of the client device 106. The webpage 200 may include content 204 and at least one creative 206. The creative 206 may be a static advertisement (e.g., text or image), an animated advertisement, a dynamic advertisement, a video advertisement, a public service announcement, or another form of information to be displayed on a screen of the client device 106.

In order to render the creative 206, the markup language of the webpage 200 may include a creative tag associated with the desired creative 206. For example, if the webpage 200 is coded with HyperText Markup Language (HTML), the creative tag may be an HTML tag or JavaScript tag that links to the creative 206. The creative tag may direct the client device 106 to retrieve the creative 206 from a creative provider 102. The location for the creative 206 may be embedded anywhere within the HTML text or within an iFrame that has been placed in the webpage 200. The webpage 200 may have one or more such locations for the displace of the creative 206. It will be appreciated that the creative tag may be a series of successive links that ultimately redirect to the creative 206. As used herein, the term creative link includes both a direct link to the creative 206 as well as a series of successive links to the creative 206 through, for example, one or more advertisement networks.

Further, the webpage 200 may have instructions for embedding a video player 210 as a part of the content to be displayed on the page. The video player 210 may be configured to play video content, such as video advertisements, to open executable files, such as Shockwave Flash files, or to execute other instructions. The video player 210 may be a separate component that is downloaded and executed by the web browser 202, such as an Adobe Flash, Apple QuickTime, or Microsoft Silverlight object; a component of the web browser 202 itself, such as a HTML 5.0 video player; or any other type of component able to render and play video content within the web browser 202. The video player may be configured to play featured video content in addition to a creative 206. The video player may also be configured to retrieve the creative 206 through a creative tag that links to the desired creative 206.

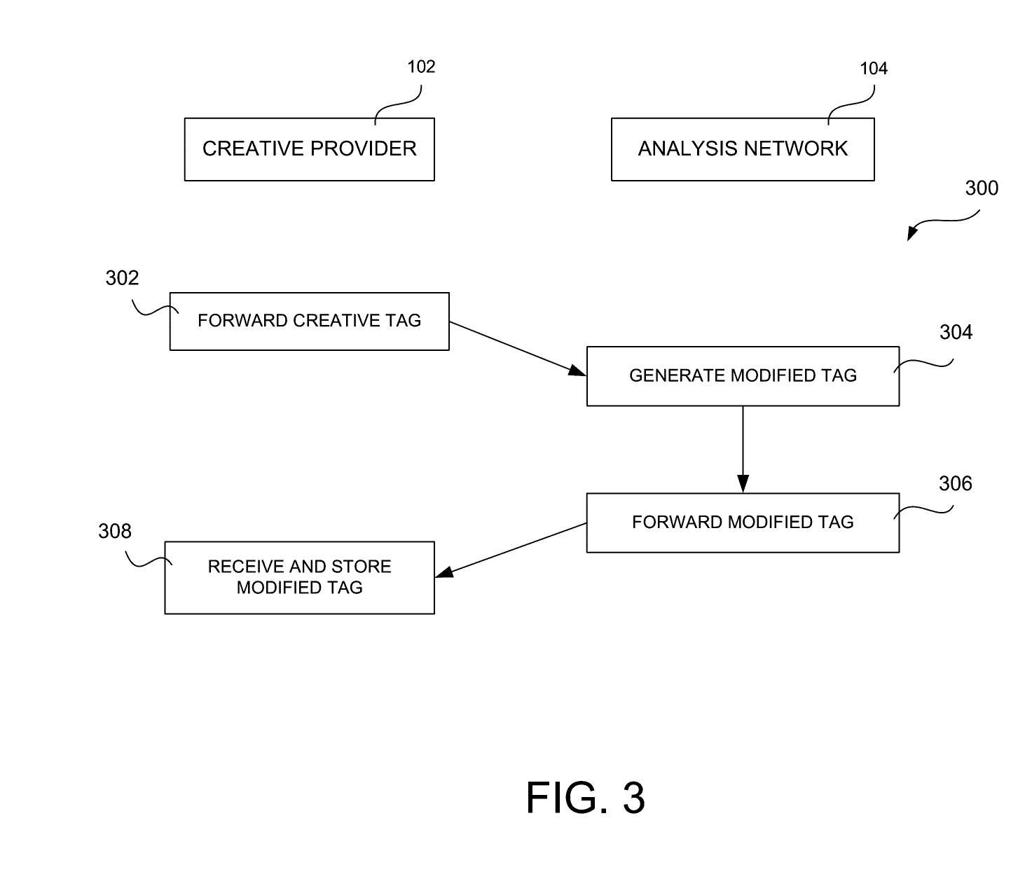

FIG. 3 illustrates an example of a process 300 for generating a modified tag from a creative tag. As mentioned previously, the creative tag is a component of a webpage that includes a link to a creative 206. When the creative tag is processed by a web browser 202, the client device 106 may open the link in the creative tag, retrieve the creative 206, and display the creative 206 on the client device 106. The creative 206 may be text, a static image, a video, or an audio file.

Initially, at step 302, the creative provider 102 forwards a creative tag to the analysis network 104. The creative tag includes either a direct or indirect link to the creative to be displayed by the web browser 202. At step 304, the analysis network 104 generates a modified tag corresponding to the creative tag received from the creative provider 102. In some aspects, the modified tag may have a one-to-one correspondence with the creative tag. For example, the modified tag may include a unique tag identifier that may be used to identify the corresponding creative tag. In other aspects, the modified tag may refer to a plurality of creative tags, such as a plurality of creative tags of a single creative provider. By storing the unique identifier of the corresponding creative tag on the analysis network 104, the analysis network 104 can retrieve the corresponding creative tag upon determination that the webpage 200 satisfies at least one parameter, as described in greater detail below. In addition, by maintaining the unique identifier of the creating tag at the analysis network, the likelihood of fraudulent redirects to alternative creatives is reduced.

In some aspects, the modified tag may include a link to instructions to generate a rating request while, in other aspects, the modified tag may include the instructions to generate the rating or the rating request. The instructions may be in JavaScript, Small Web Format (SWF), ActionScript, or another language that may be processed by the web browser 202. For example, the modified tag may include a link, such as a URL, to JavaScript code. Further, the modified tag may include the unique tag identifier. In some aspects, the unique tag identifier may be included within the link to the instructions, such that the link identifies the unique tag identifier. In some aspects, the modified tag can also include the link to the creative 206, while in other aspects, the modified tag may not include the link to the creative 206.

The instructions may be instructions to forward a rating request to the analysis network 104 or to determine a rating of the webpage 200 at the client device 106. The rating request may be processed by the analysis network 104 in order to determine whether to forward the creative tag to the client device 106, as describes in greater detail below.

At step 306, the modified tag may be forwarded from the analysis network 104 to the creative provider 102. The analysis network 104 may store the creative tag, modified tag, and/or unique tag identifier in a database of the analysis network 104. At step 308, the creative provider 102 may receive and store the modified tag in a database of the creative provider 102.

To deliver a creative, the creative provider 102 typically forwards creative tags to a content provider 100. The content provider 100 may include the creative tags on the webpage 200 to be rendered by the web browser 202 of the client device 106. Following reception of the modified tag, however, instead of forwarding creative tags, the creative provider 102 may forward modified tags to the content provider 100. The modified tags may be rendered by the web browser 202 of the client device 106 to determine the rating of the webpage 200 displayed on the client device 106 before selectively displaying the creative 206.

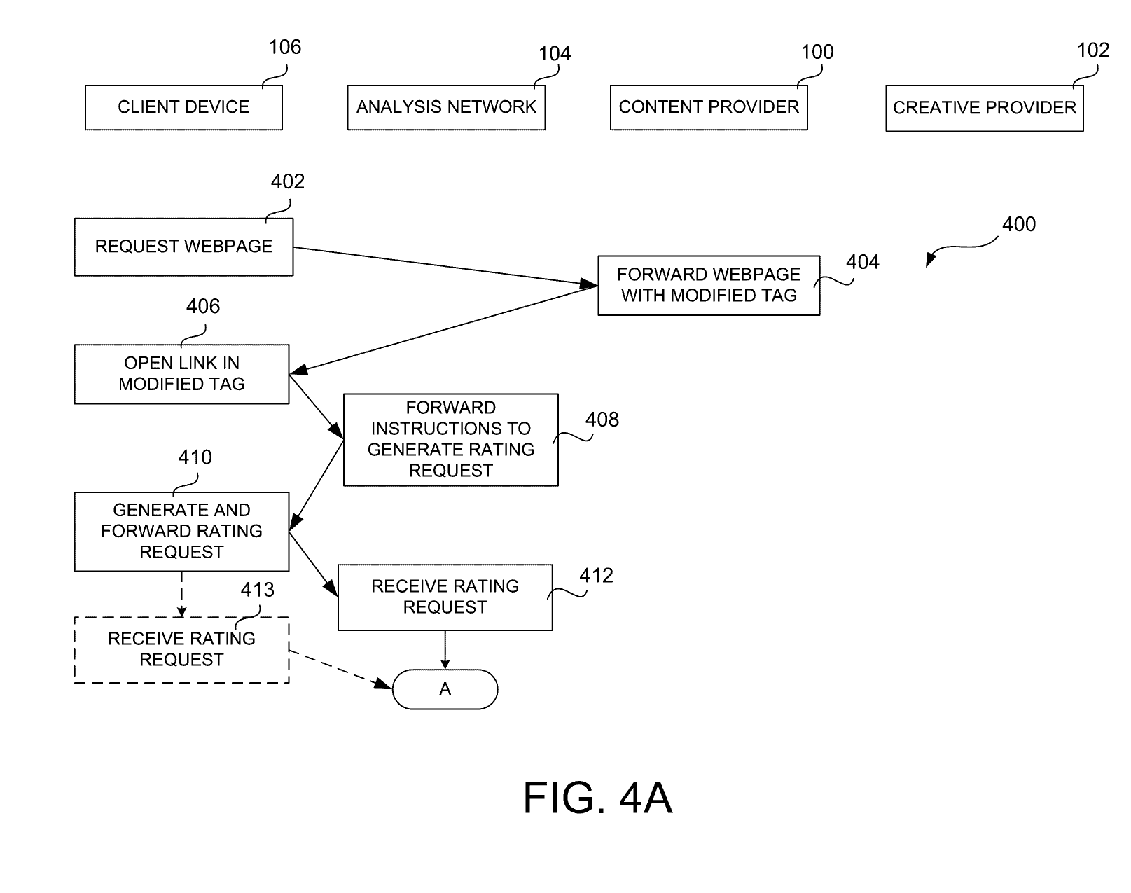

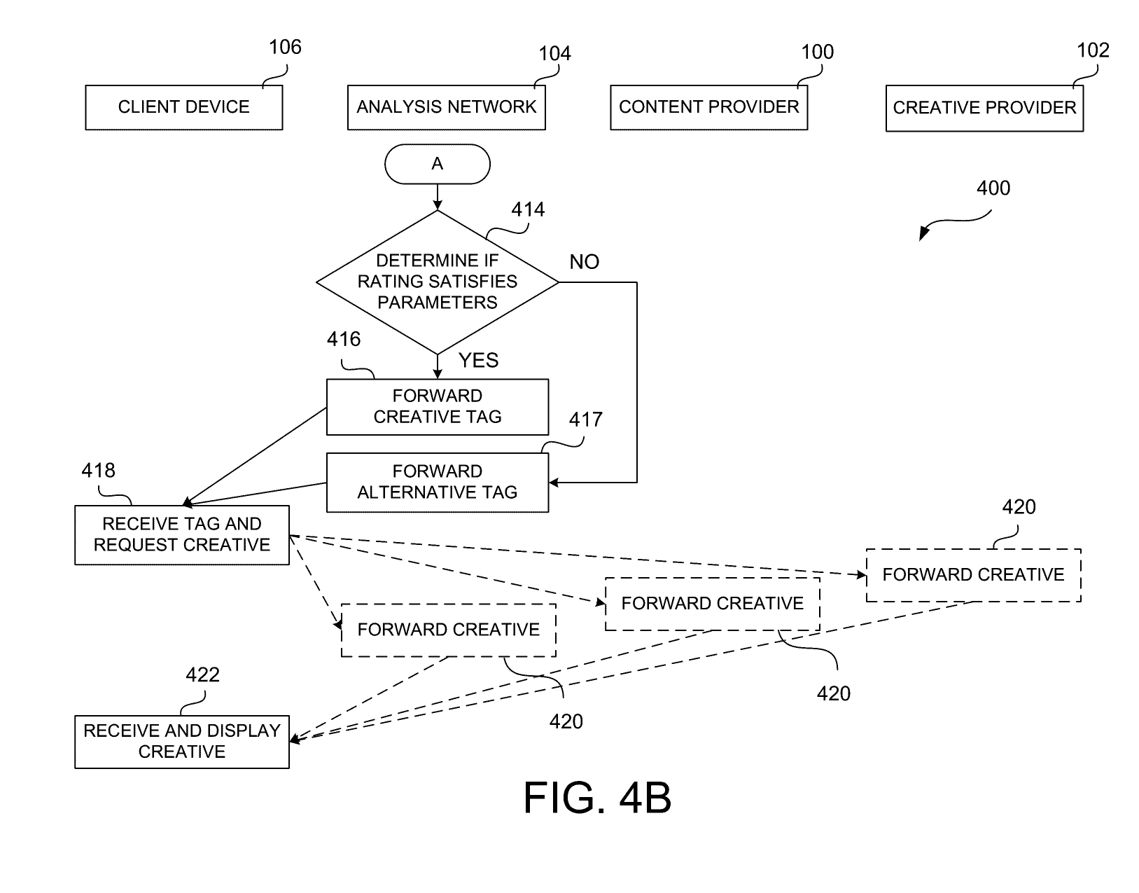

FIGS. 4A-B illustrate an exemplary process 400 for delivering a creative to the client device 106 using the modified tag. Initially, at step 402, the client device 106 may request the webpage 200 from the content provider 100. At step 404, the content provider 100 may receive the request for the webpage 200 and forward the webpage 200 including the modified tag instead of the creative tag where the content provider 100 intends to display the creative 206 within the webpage 200. The content provider 100 receives the modified tag from the creative provider 102 before the request for the webpage is received from the client device 106 in step 402. In some aspects, the webpage 200 may include a single creative and, therefore, receive a single modified tag. In other aspects, the webpage 200 may include a plurality of creatives and, therefore, receive a plurality of modified tags each corresponding to different creatives.

At step 406, the client device 106 calls the link to the instructions to forward the rating request from within the modified tag. Calling the link will then cause the client device 106 to request the instructions from the analysis network 104. In such aspects, at step 408, the analysis network 104 forwards the instructions to the client device 106. In other aspects, the modified tag may include the instructions themselves. In such aspects, the process 400 will skip step 408 and proceed directly to step 410. The instructions may be code, such as JavaScript code, to be processed at the client device 106 by the web browser 202.

At step 410, following reception of the instructions, the client device 106 may generate and forward the rating request. The rating request may be forwarded to the analysis network 104, as shown in step 412, a module on the client device 106, as shown in step 413, the content provider 100, the creative provider 102, or a combination thereof. In preferred aspects, however that the rating request is forwarded to the analysis network 104, which receives the rating request in step 412.

The rating request may be a request to determine whether the creative 206 associated with the modified tag may be displayed on the particular webpage 200 displayed by the client device 106. It is desirable for companies to protect their brand and improve impression quality of the creative 206. For example, a manufacturer of children's toys may not want their advertisements to be displayed on an adult-themed website. Further, a company may want to verify the impression of the creative 206 was not registered by non-human traffic or displayed in a way that is not visible to the user (e.g., in an invisible frame). The rating request may be used to determine whether the content provider 100, the client device 106, the webpage 200, the user of the client device 106, or other properties of the client device 106 are appropriate for the creative 206.

The rating request may include metadata to allow the creative provider 102, the analysis network 104, the client device 106, or other party to determine a rating for the impression of the creative associated with the modified tag. The metadata may include the website URL, the title of the webpage 200, at least one cookie stored on the client device 106 that may be related to the webpage 200, at least one container of the creative 206 on the webpage 200 (e.g., an iFrame), the placement of the creative 206 on the webpage 200, an identifier of the creative 206, such as the unique tag identifier associated with the creative tag, information related to the campaign of the creative 206, or other information (e.g., time of day, geographic location, IP address, operating system, device type, etc.) related to the client device 106, the webpage 200, or the creative 206. The rating request may also include a desired response time to respond to the rating request.

The creative provider 102, the analysis network 104, the client device 106, or other party will then determine a rating based on the metadata. For example, the analysis network 104 may receive the rating request containing the metadata and then calculate a rating for the webpage 200 based on the metadata. Calculation of the rating can be done in a variety of ways that include but are not limited to the application of simple methods based on the values of the metadata, or more complex methods, including statistics, signal processing, anomaly detection, machine learning, etc. The rating may also be in the form of an index that combines a variety of aspects of the metadata and values that are calculated from the metadata.

At step 416, the creative provider 102 and/or the analysis network 104 will determine whether the calculated rating satisfies a first set of parameters. The first set of parameters is used to determine whether the creative 206 may be displayed on the webpage 200 displayed by the client device 106. The set of parameters may be different depending on the creative 206, the creative tag, and/or the corresponding modified tag.

In some aspects, the rating and the first set of parameters may each be at least one alphanumeric value. To determine whether the rating satisfies the first set of parameters, the rating may be compared to the first set of parameters to determine whether an alphanumeric value of the rating is equal to, greater than, or less than at least one alphanumeric value of the first set of parameters. For example, the rating may be a Motion Picture Association of America (MPAA) rating such as G, PG, PG-13, R, or NC-17, and the analysis network 104 may determine the rating satisfies the first set of parameters if the rating matches the MPAA ratings for the creative 206. For example, the creative 206 may be authorized to be rendered on G or PG webpages. If the rating of the webpage 200 is calculated to be G or PG, then the creative 206 may be rendered on the webpage 200.

In other aspects, the rating may be a composite score for the webpage 200 based on the content of the webpage 200, the URL of the webpage 200, the publisher of the webpage 200, or other properties of the webpage 200. The composite score may be an alphanumeric value, and the process 400 may determine the rating satisfies the first set of parameters if the composite score is less than or greater than a particular alphanumeric value. For example, the creative 206 may be authorized to be rendered on webpages having an adult rating of less than 50. If the rating of the webpage 200 is calculated to be 75, then the creative 206 may not be rendered on the webpage 200.

In some aspects, the creative provider 102, the analysis network 104, and/or the client device 106 may determine that the rating satisfies the first set of parameters by determining whether text within webpage 200, a URL of the webpage 200, a title of the webpage 200, or other content associated with the webpage 200 includes any unapproved keywords for a particular creative 206. The unapproved keywords may be contained in a blacklist that may be stored at the content provider 100, the creative provider 102, the analysis network 104 and/or the client device 106. The analysis network 104 and/or client device 106 may retrieve the blacklist when determining whether the webpage 200 includes the unapproved keywords. In some aspects, a unique blacklist may be maintained for each creative 206 or creative campaign. The creative provider 102, client device 106 and/or the analysis network 104 may be able to add, remove, or otherwise modify keywords in the blacklist.

In some aspects, the creative provider 102 and/or the analysis network 104 may determine that the rating satisfies the first set of parameters by determining whether the webpage 200 is from an approved and/or an unapproved domain or IP addresses. Domains may include traditional generic top level domains, such as .com, .org, .xxx, etc.; country-code top level domains, such as .uk, .us, .au, etc.; new generic top level domains, such as .amazon, .google, .sucks, .sex, etc.; second level domains, such as example.com, abcdefg.org, sex.com, etc.; or other levels of the domain name syntax. A list of approved domains and/or unapproved domains may be stored at the content provider 100, the creative provider 102, the analysis network 104 and/or the client device 106. The analysis network 104 and/or client device 106 may verify that the webpage 200 is from an approved domain or IP address, and/or is not from an unapproved domain or IP address. A unique list of unapproved and/or approved domains may be maintained for each creative 206 or creative campaign. The creative provider 102, client device 106 and/or the analysis network 104 may be able to add, remove, or otherwise modify the list of approved and/or unapproved domains or IP addresses.

In some aspects, the creative provider 102 and/or the analysis network 104 may determine that the rating satisfies the first set of parameters by determining whether the rating request was generated or registered by non-human traffic or that the creative would be displayed in a way that cannot be seen by the user. The creative provider 102 and/or the analysis network 104 may determine the rating does not satisfy the first set of parameters if the request was made by non-human traffic. The creative provider 102 and/or the analysis network 104 may implement various methods and algorithms known in the art to detect non-human traffic. The methods may use the metadata received in the rating request to detect non-human traffic.

In some aspects, the creative provider 102 and/or the analysis network 104 may determine that the rating satisfies the first set of parameters by determining whether the creative tag corresponding to the rating request has been previously forwarded to the same or a different client device 106 displaying the same webpage 200. For example, if the analysis network 104 has previously determined a creative tag from the creative provider 102 was forwarded to a client device 106 displaying the webpage 200, the analysis network 104 may forward the creative tag to the client device 106 without further analysis or processing for the same creative tag to be displaying on the same webpage 200 on the same or a different client device 106.

If the creative provider 102 and/or the analysis network 104 determines that the rating satisfies a first set of parameters, the creative provider 102 and/or the analysis network 104 forwards the creative tag corresponding to the modified tag in step 416. As discussed above, the creative provider 102 and/or the analysis network 104 may store a unique tag identifier corresponding to the creative tag and the creative provider 102 and/or the analysis network 104 will select and retrieve the original creative tag to forward based on the unique tag identifier.

If the creative provider 102 and/or the analysis network 104 determines that the rating does not satisfy the first set of parameters, the creative provider 102 and/or the analysis network 104 will not forward the creative tag corresponding to the modified tag. Instead, the creative provider 102 and/or the analysis network 104 may forward an alternative tag that may contain a link to a default creative in step 417. The default creative may include a public service announcement, a pre-approved creative, or another creative that may be appropriate for display on the webpage 200. The alternative tag may link to a default creative that is hosted by a content provider 100, a creative provider 102, an analysis network 104, or another party.

At step 418, the client device 106 will open the direct or indirect link to the creative contained in the tag received from the analysis network 104. The client device 106 then forwards a request for the original creative or the alternative creative to the content provider 100, the creative provider 102, the analysis network 104, or another party, depending on the link contained in the tag. The request for the creative may include a unique web score. The web score may be generated using some of the same information used to generate the rating request. For example, the web score may be generated based on information from the non-human traffic detection methods described above or metadata related to the website. The web score may assist in the party that receives the request of a creative in the delivery of that creative. The content provider 100, the creative provider 102, and/or the analysis network 104 may log and track any information related to the delivery of the creative 206 and/or web score for accounting and auditing purposes.

At step 420, the party that receives the request for the creative will forward the corresponding original creative or alternative creative to the client device 106. If the request includes the unique web score, the web score can be used to determine the exact creative to be delivered. In modern programmatic ad environments, a content provider 100 seeking to display a creative will make a request through a supply side platform. A corresponding demand side platform will hold an auction where creative providers 102 will bid on the price they are willing to pay in order to display their respective creatives on the webpage of the content provider 100. The web score included in the request at step 420 may be used by these creative providers 102 to determine their bid price. For example, if the web score is more favorable, a creative provider 102 may be willing to pay more to display their creative. This bidding process is automated and occurs within the span of milliseconds. At step 424, the client device 106 receives the creative 206 and enables the creative for display.

Certain aspects of the process of FIGS. 3, 4A, and 4B may be implemented as or using a computer program or set of programs. The computer programs may exist in a variety of forms both active and inactive. For example, the computer programs may exist as software program(s) comprised of program instructions in source code, object code, scripts, executable code or other formats, firmware programs(s), or hardware description language (HDL) files. Any of the above may be embodied on a non-transitory computer readable medium, which include storage devices, in compressed or uncompressed form. Exemplary computer readable storage devices may include conventional computer system random access memory (RAM), read-only memory (ROM), erasable, programmable memory (EPROM), electrically erasable, programmable memory (EEPROM), and magnetic or optical disks or tapes.

Certain aspects of the process of FIGS. 3, 4A, and 4B may utilize or include a computer system, which may include one or more processors coupled to memories operating under control of or in conjunction with an operating system. The processors may be included in one or more servers, clusters, or other computers or hardware resources, or may be implemented using cloud-based resources. The processors may be programmed or configured to execute computer-implemented instructions to perform the steps of the processes disclosed herein.

While the process for delivering a creative has been described in terms of what may be considered to be specific aspects, this disclosure need not be limited to the disclosed aspects. Additional modifications and improvements may be apparent to those skilled in the art. As such, this disclosure is intended to cover various modifications and similar arrangements included within the spirit and scope of the claims, the scope of which should be accorded the broadest interpretation so as to encompass all such modifications and similar methods. The present disclosure should be considered as illustrative and not restrictive.

1. A computer-implemented method for delivering a creative, the computer implemented method comprising:
receiving, at an analysis network and from a creative provider, a first tag comprising a first link to the creative to be displayed on a webpage to be displayed on a first device;
generating, at the analysis network, a second tag corresponding to the first tag, the second tag comprising a second link to a first set of instructions comprising instructions to forward a first rating request;
forwarding, from the analysis network and to the creative provider, the second tag,
determining, based on first metadata of the first rating request, that a first rating satisfies a first set of parameters; and
forwarding, from the analysis network, the first tag comprising the first link to the creative in response to the determination that the first rating satisfies the first set of parameters.

2. The computer-implemented method of claim 1, further comprising:
receiving, at the analysis network and from the first device, the first rating request comprising the first metadata corresponding to the webpage to be displayed on the first device, wherein
determining that the first rating satisfies the first set of parameters comprises:
determining, at the analysis network, the first rating based on the first metadata of the first rating request, and
determining, at the analysis network, that the first rating satisfies the first set of parameters.

3. The computer-implemented method of claim 1, further comprising:
receiving, at the first device, the first rating request comprising the first metadata corresponding to the webpage to be displayed on the first device, wherein
determining that the first rating satisfies the first set of parameters comprises:
determining, at the first device, the first rating based on the first metadata of the first rating request, and
determining, at the analysis network, that the first rating satisfies the first set of parameters.

4. The computer-implemented method of claim 1, further comprising:
receiving, at the analysis network, a second rating request comprising second metadata corresponding to another webpage;
determining, at the analysis network, a second rating based on the second metadata of the second rating request;
determining, at the analysis network, that the second rating does not satisfy the first set of parameters; and
forwarding, from the analysis network, a third tag comprising a third link to a second creative in response to the determination that the second rating does not satisfy the first set of parameters.

5. The computer-implemented method of claim 4, wherein the second creative comprises a public service announcement.

6. The computer-implemented method of claim 4, wherein determining that the second rating based on second metadata of the second rating request does not satisfy the first set of parameters comprises determining that the second rating request was non-human traffic or that the creative could not be viewed.

7. The computer-implemented method of claim 1, wherein the first metadata comprises a URL of the webpage.

8. The computer-implemented method of claim 7, wherein the first metadata further comprises at least one of: a container of the creative, at least one cookie from the first device, a placement location of the creative, an identifier of the creative, and a response time of the first rating request.

9. The computer-implemented method of claim 1, wherein:
the first rating is a first alphanumeric value,
the first set of parameters is at least one alphanumeric value, and
determining that the first rating satisfies the first set of parameters comprises comparing the first alphanumeric value of the first rating to the at least one alphanumeric value of the first set of parameters.

10. The computer-implemented method of claim 9, wherein comparing the first alphanumeric value of the first rating to the at least one alphanumeric value of the first set of parameters comprises determining that the first alphanumeric value of the first rating is equal to the at least one alphanumeric value of the first set of parameters.

11. The computer-implemented method of claim 9, wherein comparing the first alphanumeric value of the first rating to the at least one alphanumeric value of the first set of parameters comprises determining that the first alphanumeric value of the first rating is less than the at least one alphanumeric value of the first set of parameters.

12. The computer-implemented method of claim 9, wherein comparing the first alphanumeric value of the first rating to the at least one alphanumeric value of the first set of parameters comprises determining that the first alphanumeric value of the first rating is greater than the at least one alphanumeric value of the first set of parameters.

13. The computer-implemented method of claim 1, wherein determining that the first rating satisfies the first set of parameters comprises determining that the webpage to be displayed on the first device does not include at least one unapproved keywords.

14. The computer-implemented method of claim 1, wherein determining that the first rating satisfies the first set of parameters comprises determining that the webpage to be displayed on the first device is from an approved domain or an approved IP address.

15. The computer-implemented method of claim 1, wherein the second tag comprises a JavaScript tag.

16. The computer-implemented method of claim 1, wherein determining that the first rating satisfies the first set of parameters comprises determining that the first link to the creative to be displayed on the webpage was previously forwarded to a second device displaying the same webpage, wherein the second device is different from the first device.

17. The computer-implemented method of claim 1, wherein:
the second tag comprises a tag identifier corresponding to the first tag,
forwarding the first tag comprising the first link to the creative in response to the determination that the first rating satisfies the first set of parameters comprises selecting the first tag to forward based on the tag identifier.

18. The computer-implemented method of claim 1, wherein forwarding the first tag comprising the first link to the creative in response to the determination that the first rating satisfies the first set of parameters comprises forwarding, from the analysis network to the first device, the first tag comprising the first link to the creative in response to the determination that the first rating satisfies the first set of parameters.

19. A system for delivering a creative, the system comprising at least one processor connected to at least one storage device, the system being configured to:
receive, at an analysis network and from a creative provider, a first tag comprising a first link to the creative to be displayed on a webpage to be displayed on a first device;
generate, at the analysis network, a second tag corresponding to the first tag, the second tag comprising a second link to a first set of instructions comprising instructions to forward a first rating request;
forward, from the analysis network and to the creative provider, the second tag,
determine, based on first metadata of the first rating request, that a first rating satisfies a first set of parameters; and
forward, from the analysis network, the first tag comprising the first link to the creative in response to the determination that the first rating satisfies the first set of parameters.

20. An article of manufacture comprising non-transitory machine-readable media having instructions encoded thereon for causing a controller to:
receive, at an analysis network and from a creative provider, a first tag comprising a first link to the creative to be displayed on a webpage to be displayed on a first device;
generate, at the analysis network, a second tag corresponding to the first tag, the second tag comprising a second link to a first set of instructions comprising instructions to forward a first rating request;
forward, from the analysis network and to the creative provider, the second tag,
determine, based on first metadata of the first rating request, that a first rating satisfies a first set of parameters; and
forward, from the analysis network, the first tag comprising the first link to the creative in response to the determination that the first rating satisfies the first set of parameters.
